(19) United States
(12) Patent Application Publication
(10) Pub. No.: US 2026/0332909 A1
(43) Pub. Date: Oct. 22, 2026

(54) PHOTON COUNTING CIRCUITRY AND PHOTON COUNTING METHOD

(71) Applicant: Sony Semiconductor Solutions Corporation, Kanagawa (JP)

(72) Inventor: Qing DING, Basingstoke (GB)

(73) Assignee: Sony Semiconductor Solutions Corporation, Kanagawa (JP)

(21) Appl. No.: 19/110,444

(22) PCT Filed: Sep. 19, 2023
(86) PCT No.: PCT/EP2023/075832

§ 371 Date: Mar. 11, 2025

(30) Foreign Application Priority Data
Sep. 22, 2022 (EP) 22197166.6

(51) Int. Cl. H04N 25/773; G01S 7/4865

(52) U.S. Cl. CPC H04N 25/773; G01S 7/4865

(57) ABSTRACT

The present disclosure generally pertains to photon counting circuitry (11), configured to: determine, based on a degree of overlap in time of at least two pixel signals (CLK1, CLK2) of at least two pixels (SPAD1, SPAD2) of a photon counting time-of-flight sensor (10), whether a signal coincidence of the at least two pixel signals (CLK1, CLK2) is present, for setting a counting operation mode to a coincidence counting operation mode, if the signal coincidence is present, wherein counts of the at least two pixel signals are counted together in the coincidence counting operation mode; and generate a coincidence counting signal (YES) for setting the counting operation mode to the coincidence counting operation mode. Preferably, the coincidence counting signal corresponds to that pixel signal of the at least two pixel signals (CLK1, CLK2) which is later in time. For example, only one count would be recorded when there is no coincidence detection. However, a count number of a common counter may be multiplied by two to reproduce the real event number. Thereby, more counts may be accumulated which may optimize a signal to noise ratio. Moreover, silicon area may be saved by accounting for a correlation between/among adjacent/neighboring pixels in the sensor. It is made use of this correlation to save the total counter bit length of two or more pixels in a pixel group. Hence, this temporal correlation may be determined and coincident counts may be dynamically stored into a common (shared) counter.

### TECHNICAL FIELD

The present disclosure generally pertains to photon counting circuitry and to a photon counting method.

### TECHNICAL BACKGROUND

Generally, it is known to determine a distance based on a roundtrip delay of emitted light. For example, pulsed or modulated light may be emitted and its time for arriving back at an image sensor may be measured. Such technology may be called direct time-of-flight (dToF).

In dToF, photons may be “counted” by means of a time to digital conversion and stored in histograms. Photon detection may be realized by detecting a photoelectronic avalanche, e.g., based on SPAD (single photon avalanche diode) technology, an APD (avalanche photodiode), or the like. The photoelectronic signal may be indicative either of a number of photons or for single photons and the number of photons may be stored in respective counters, which may need a sufficiently high bit length for storing a sufficiently high amount of photons.

Moreover, photon counting technology may be known, e.g., based on photodiodes in which a determined voltage, or the like, may be indicative of a number of photons.

Although there exist techniques for counting photons, it is generally desirable to provide photon counting circuitry and a photon counting method.

### SUMMARY

According to a first aspect, the disclosure provides photon counting circuitry, configured to:
determine, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
generate a coincidence counting signal for setting the counting operation mode to the coincidence counting operation mode.

According to a second aspect, the disclosure provides a photon counting method, comprising:
determining, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
generating a coincidence counting signal for setting the counting operation mode to the coincidence counting operation mode.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a schematic diagram of a SPAD based photon counting pixel according to the present disclosure;

FIG. 2 depicts, in a block diagram, an embodiment of photon circuitry including photon counting circuitry according to the present disclosure;

FIG. 3 depicts a further embodiment of photon circuitry including photon counting circuitry according to the present disclosure;

FIG. 4 depicts timing diagrams for the photon counting circuitry of FIG. 3;

FIG. 5 depicts photon counting ToF circuitry and photon counting circuitry according to the present disclosure operating in a non-coincidence counting mode;

FIG. 6 depicts photon counting ToF circuitry and photon counting circuitry according to the present disclosure operating in a coincidence counting mode;

FIG. 7 depicts an embodiment of a photon counting method according to the present disclosure in which it is determined whether coincidence or non-coincidence is present;

FIG. 8 depicts a further embodiment of a photon counting method according to the present disclosure in which non-coincidence is determined;

FIG. 9 depicts a further embodiment of a photon counting method according to the present disclosure in which it is determined that coincidence is present;

FIG. 10 depicts a further embodiment of a photon counting method according to the present disclosure in which respective counters are set as common counters or individual counters depending on whether coincidence is present; and

FIG. 11 depicts a high-level diagram of a photon counting ToF camera including photon counting circuitry according to the present disclosure.

### DETAILED DESCRIPTION OF EMBODIMENTS

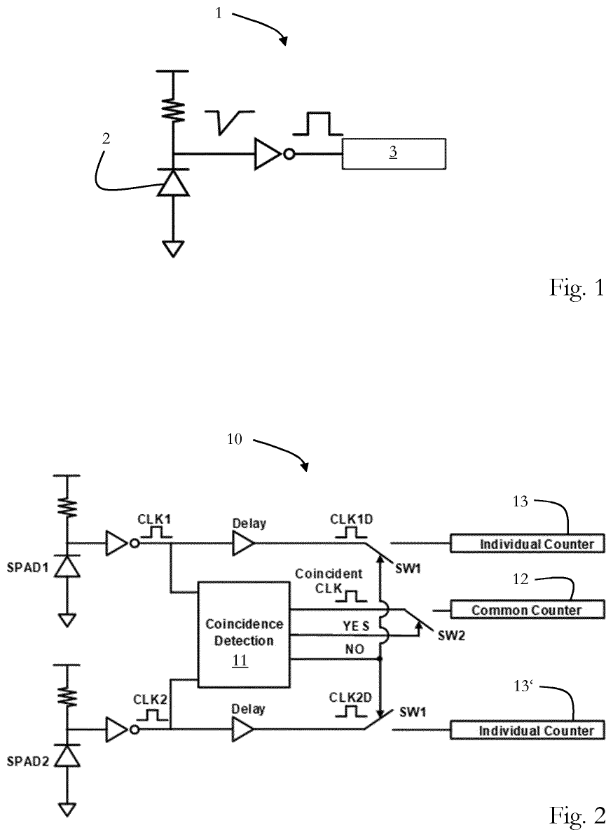

Before a detailed description of the embodiments starting with FIG. 1 is given, general explanations are made.

As mentioned in the outset, methods for counting photons for determining a distance or a depth are generally known. However, as many counter bits as possible may be needed to increase a DR (dynamic range). It has been recognized that it may be desirable to increase an effective bit length of the counters and at the same time to reduce needed silicon area, thereby providing for a smaller pitch of a pixel design.

It has further been recognized that temporal (in time domain) coherence/coincidence between/among (adjacent/neighboring, without limiting the present disclosure in that regard) pixels of a photon counting ToF sensor may be present which may be used for decreasing the counter length. It should be noted that the present disclosure is not limited to active light sensing as known for ToF, but also photons deriving from passive light (e.g., ambient light, solar light, or the like) may be counted, also based on other sensor types.

Moreover, it has been recognized that it may be desirable to provide a SPAD/APD based photon counting sensor which may be used in binning mode. In sensors of the state of the art, it has been recognized that is difficult to implement binning without identifying the events generated at the same time. If no identifying mechanism is implemented, in known sensors, all events generated at the same time will be treated as one event. However, this may result in a drop of total effective counts and thus reduce an SNR (signal-to-noise ratio), power efficiency, and the like.

Therefore, some embodiments pertain to photon counting circuitry, configured to: determine, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and generate a coincidence counting signal for setting the counting operation mode to the coincidence counting operation mode.

Circuitry may pertain to any entity or multitude of entity which may be usable in the context of photon counting (time-of-flight) measurements, such as one or multiple processors (e.g., CPU (central processing unit), GPU (graphics processing unit)), one or multiple FPGAs (field-programmable gate array), or the like. Circuitry may include or may be applicable to a (system of) camera(s), a (system of) computer(s), server(s), or the like.

The photon counting circuitry may be used for counting photons based on photoelectronic signals which may be generated by one or multiple SPADs (single photon avalanche diode), APDs (avalanche photodiode), or any other circuitry which may generate a signal which is indicative of one or multiple photons, such that the number of incident photons may be derived.

Generally, the present disclosure is not limited to photon counting ToF technology since 2D (two-dimensional) active or passive imaging may be applied with the principles of the present disclosure, as well. For example, the present disclosure may generally be applied based on photon counting, i.e., any type of technology which may count photons apart from ToF. Hence, in some embodiments, the present disclosure may generally pertain to photon counting circuitry, photodetection circuitry, 2D imaging circuitry, 3D imaging circuitry, or the like.

Also SPADs, or the like, may be used in pixels of a photon counting time-of-flight sensor according to the present disclosure for photodetection or photocounting. If a photon is incident on a pixel, the pixel may generate a pixel signal which may overlap in time with another pixel signal of another pixel of the photon counting ToF sensor. The sensor may be any type of sensor, such as a single layer sensor, a stacked sensor, a BSI (back-side illuminated) sensor, FSI (front side illuminated sensor), or the like.

Overlap in time may refer to a case in which the at least two pixel signals are generated roughly at the same time. If they are indicated at exactly the same time (and, in some embodiments, if they also end at the same they), their degree of overlap may be determined to be a hundred percent (or any other way of expressing that they are generated fully in parallel). The respective internal times for determining the degree of overlap in time may differ from pixel to pixel and may be calibrated respectively, such that, globally, it may be determined that the at least two pixel signals overlap to a certain degree.

The degree may be smaller than a hundred percent (or “fully”) if they are not generated exactly at the same time, i.e., when the at least two pixel signals are shifted in time with respect to each other.

For example, they may not overlap at all or overlap to a certain degree (e.g., fifty percent). For example, assuming the pixel signals have the same length: if a first pixel signal is generated at a first point of time and the second pixel signal may be generated at a second point of time which lies in the middle of the first point of time, the overlap may be fifty percent.

If the degree of overlap in time is sufficiently high (i.e., above or equal to a predetermined threshold), it may be determined that the signals are coincident or, in other words, that a signal coincidence of the at least two pixel signals is present. Of course, more than two pixel signals may be determined to have coincidence or not in a similar or same way.

If the signal coincidence is present, a coincidence counting operation mode may be applied according to the present disclosure. In the coincidence counting operation mode, counts which are indicated by each of the at least two pixel signals are counted together (e.g., counted as one). For example, the respective counts may be counted as one in a common counter which may be common for the at least two pixels, in case coincidence is present.

Apart from the coincidence counting operation mode, a non-coincidence counting operation mode may be determined as a counting operation mode, in case that no signal coincidence of the at least two pixel signals is present. In such a case, the respective counts may be stored in individual counters for the at least two pixels.

For indicating or setting that the counting operation mode is the coincidence counting operation mode, a coincidence counting signal may be generated. The coincidence counting signal may correspond to one of the at least two pixel signals, which may be reused or forwarded to respective circuitry for “activating” the common counter (or any other circuitry for storing counts, such as a histogram).

For indicating or setting the non-coincidence counting operation mode as the counting operation mode, it may not be necessary to generate a respective signal since the non-coincidence counting operation mode may be determined based on an absence of the signal, without limiting the present disclosure in that regard since, as for the coincidence counting operation mode, the non-coincidence counting operation mode may be explicitly set with a signal.

In some embodiments, the non-coincidence counting operation mode may be indicated with a respective signal and the coincidence counting operation mode may be determined based on an absence of a signal.

According to the present disclosure, silicon area may be saved. In a photon counting sensor according to the state of the art, a counter with a sufficiently high bit length may be needed to store all the generated events. However, it may be challenging to implement a small pixel pitch design since the counters as in the state of the art may occupy too much silicon area.

However, according to the present disclosure, it has been recognized that it may be desirable to account for a correlation between/among adjacent/neighboring pixels in the sensor.

It is made use of this correlation to save the total counter bit length of two or more pixels in a pixel group (e.g., 1×2, 2×1, 2×2, or the like). Hence, according to the present disclosure, this temporal correlation (i.e., coincidence) may be detected/determined and coincident counts may be stored into a common (shared) counter. By doing so, unlike counting by individual counters for each pixel, there may be no need to store coincident counts multiple times in each of the individual counters, but only once in the common counter. Therefore, a total counter bit length of the pixel group may be reduced and thus, silicon area may be saved.

In some embodiments, the photon counting circuitry is further configured to: determine the counting operation mode as a non-coincidence counting operation mode, if the degree of overlap in time of the at least two pixel signals is below a predetermined threshold, as discussed herein.

In some embodiments, the photon counting circuitry is further configured to: store, in the coincidence counting operation mode, photon counts which are indicated by the at least two pixel signals in a common counter which is common for the at least two pixels, as discussed herein.

In some embodiments, the photon counting circuitry is further configured to: store, in the coincidence counting operation mode, one coincident photon count of the at least two pixel signals as one count in the common counter, as discussed herein.

In some embodiments, the photon counting circuitry is further configured to: store, in the non-coincidence counting operation mode, photon counts which are indicated by the at least two pixel signals in individual counters for each of the at least two pixel signals, as discussed herein.

In some embodiments, the coincidence counting signal is a clock signal. However, as discussed above, the coincidence counting signal may be one of the at least two pixel signals, which may be reused, or the like (also as a clock signal). Moreover, the clock signal may be generated in response to reception of one of the at least two pixel signals.

In some embodiments, the coincidence counting signal corresponds to that pixel signal of the at least two pixel signals which is later in time. Thereby, it may be first ensured that coincidence is present before controlling the respective counters since it may take a certain amount of time to determine whether the coincidence is present.

In some embodiments, the photon counting further includes at least three counters including at least one common counter for the coincidence counting operation mode, and at least two individual counters for the non-coincidence counting operation mode, as will be discussed below (e.g., under reference of FIG. 2, 5, or 6).

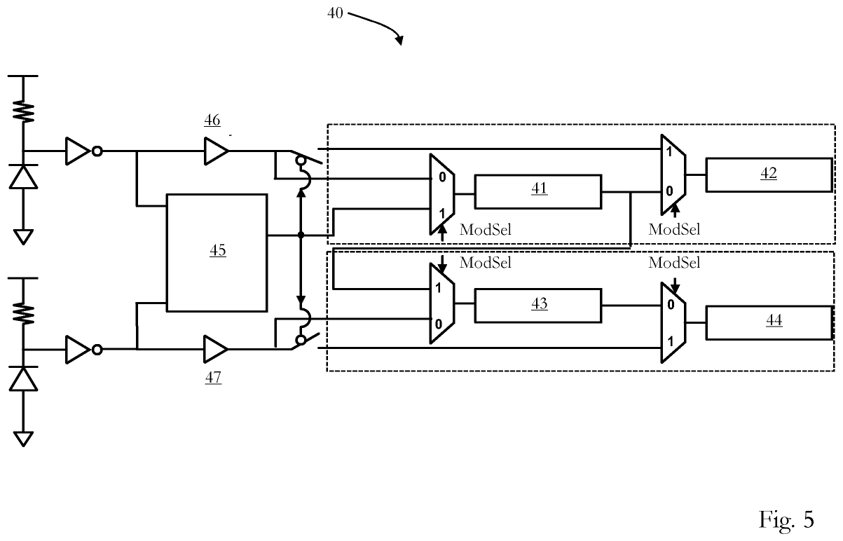

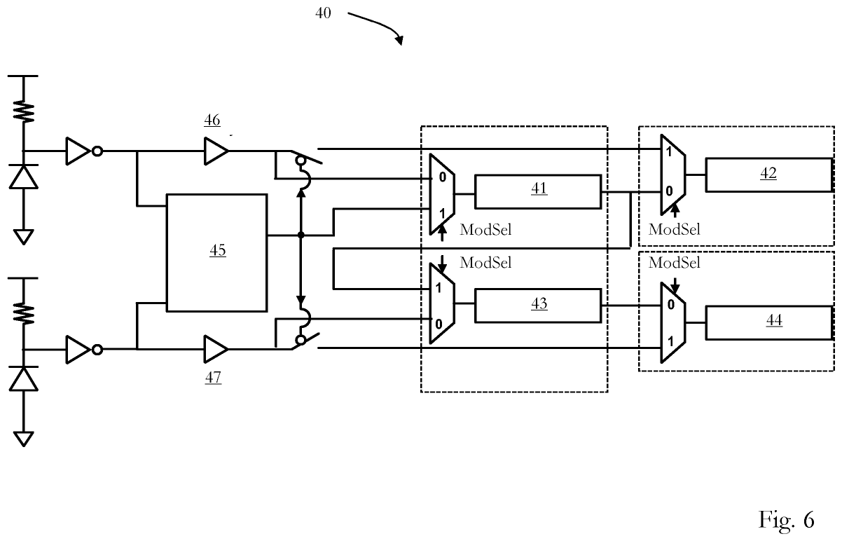

In some embodiments, the photon counting circuitry further includes four counters including a first to fourth counter, and the circuitry may be further configured to: set, based on the coincidence counting signal, the first and the second counter as a common counter for the coincidence counting operation mode, as will be discussed below (e.g., under reference of FIGS. 5 and 6).

In some embodiments, the photon counting circuitry is further configured to: set, based on an absence of the coincidence counting signal, the first and the third counter as a first individual counter and the second and the fourth counter as a second individual counter, as will be discussed below (e.g., with under reference of FIGS. 5 and 6).

Generally, by setting the respective counters as mentioned above, dynamically adaptable counting circuitry may be provided which may be able to dynamically switch between common counting and individual counting depending on whether coincidence is present. Thereby, a storage amount may be optimized, e.g., in that needed storage may be decreased (if two counts are stored together as one) and possible storage is increased, because, for example, two (smaller) counters may serve as one large counter which stores the coincident counts. If non-coincidence is present, the common counter may be dynamically set to individual counters, thereby optimizing spatial resolution in the non-coincident case.

Some embodiments pertain to a photon counting method, including: determining, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and generating a coincidence counting signal for setting the counting operation mode to the coincidence counting operation mode, as discussed herein.

The methods described herein may be carried out by photon counting circuitry according to the present disclosure.

In some embodiments the photon counting method further includes: determining the counting operation mode as a non-coincidence counting operation mode, if the degree of overlap in time of the at least two pixel signals is below a predetermined threshold, as discussed herein. In some embodiments, the photon counting method further includes: storing, in the coincidence counting operation mode, photon counts which are indicated by the at least two pixel signals in a common counter which is common for the at least two pixels, as discussed herein. In some embodiments, the photon counting method further includes: storing, in the coincidence counting operation mode, one coincident photon count of the at least two pixel signals as one count in the common counter, as discussed herein. In some embodiments, the photon counting method further includes: storing, in the non-coincidence counting operation mode, photon counts which are indicated by the at least two pixel signals in individual counters for each of the at least two pixel signals, as discussed herein. In some embodiments, the coincidence counting signal is a clock signal, as discussed herein. In some embodiments, the coincidence counting signal corresponds to that pixel signal of the at least two pixel signals which is later in time, as discussed herein. In some embodiments, the photon counting method is applied with at least three counters including at least one common counter for the coincidence counting operation mode, and at least two individual counters for the non-coincidence counting operation mode, as discussed herein. In some embodiments, the photon counting method is applied with four counters including a first to fourth counter, the method further including: setting, based on the coincidence counting signal, the first and the second counter as a common counter for the coincidence counting operation mode, as discussed herein. In some embodiments, the photon counting method further including: setting, based on an absence of the coincidence counting signal, the first and the third counter as a first individual counter and the second and the fourth counter as a second individual counter, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, a schematic diagram of a SPAD based photon counting pixel 1 and PFE (Pixel Front Element (circuit)) is shown. In this embodiment, a SPAD 2 device biased at Geiger-mode generates a pulse at its anode, i.e., a so-called “event” is generated. This pulse may be filtered by a comparator/inverter (or any other interface circuitry) and then the event is counted by a counter 3.

It should be noted that, in FIG. 1, for illustrational purposes, two pixels are shown, but generally, the present disclosure may be applied to more pixels as well.

In this embodiment, for simplification, the SPAD 2 is depicted as a passive quenched structure, but it may be an active quenched SPAD, external clock controlled quenched SPAD, or the like. Moreover, the present disclosure is not limited to SPADs, but may also be applied based on one or multiple APDs or any other pixels that has similar features of generating a digital event in response to a photon being incident. The counter 3 is simplified by a counter block, but may be a ripple counter, LFSR counter or any other circuitry which is capable of accumulating events that is generated by the SPAD.

FIG. 2 depicts, in a block diagram, an embodiment of photon counting ToF circuitry 10 including photon counting circuitry 11, which is embodied as a “coincidence detection” block 11.

In this embodiments, two pixels (as already shown in FIG. 1) are shown (without limiting the present disclosure in that regard), which are each based on SPADs, i.e., SPAD1 and SPAD2. The coincidence detection block 11 is configured to monitor an output of clocks CLK1 and CLK2 of SPAD1 and SPAD2, respectively.

If clock signals (corresponding to a pixel signal, as described above) generated by the two SPADs, i.e., CLK1 and CLK2, are coincident signals or have a sufficiently high overlap in the time domain, the coincidence detection block judges them as coincident events and output YES (which means that they are coincident events; without limiting the present disclosure to outputting YES since any other way of expressing coincidence may be envisaged) to turn on switch SW2, thereby letting a generated coincident clock signal CLK to pass through switch SW2 to a common counter 12. In this process, another switch SW1 is turned off (i.e., is kept in a disconnected state).

If the clock signals CLK1 and CLK2 are not coincident signals, the coincidence detection block judges them as non-coincident events and outputs NO (which means that they are no coincident events), thereby turning on switch SW1 to let the two clock signals pass through switch SW1 into individual counters 13 for SPAD1 and 13′ for SPAD2.

In some embodiments, some time may be needed for the coincidence circuit to complete the judgment and, such that buffered clock signals CLK1D and CLK2D are used, which are respective buffered versions of CLK1 and CLK2 caused by a delay cell.

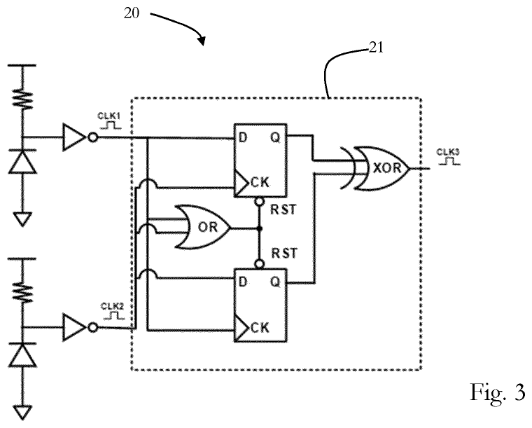

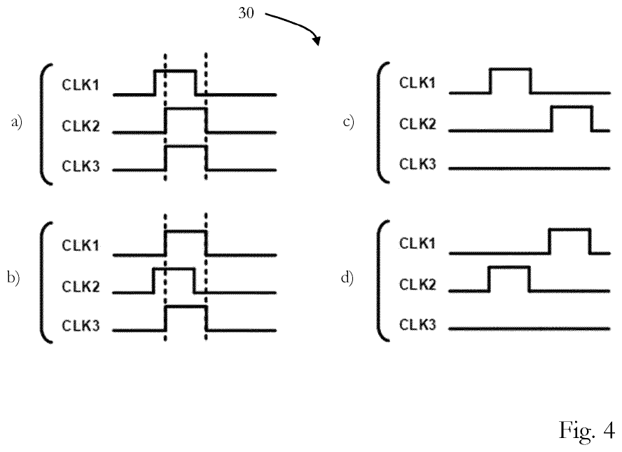

FIG. 3 and FIG. 4 depict a further embodiment of photon counting ToF circuitry 20 including photon counting circuitry 21 according to the present disclosure (FIG. 3) and clock diagrams 30 (in FIG. 4) for demonstrating how the photon counting circuitry 21 may be controlled.

In the embodiment of FIG. 3, the outputs of the two SPADs, i.e. CLK1 and CLK2 are monitored and generate a further clock signal CLK3. In this embodiment, the photon counting circuitry 21 is configured to detect an overlap between the clock signals CLK1 and CLK2 and output CLK3 when the overlap between CLK1 and CLK2 is detected.

Diagrams a) and b) of FIG. 4 depict embodiments of the clock signals in the case of coincidence, whereas diagrams b) and c) depict embodiments of the clock signals in the case of non-coincidence.

As can be taken from diagrams a) and b) clock signal CLK3 corresponds to that clock signal of the clock signals CLK1 and CLK2, which is later in time. However, CLK3 is only output, when the degree of overlap of CLK1 and CLK2 is sufficient.

If no coincidence is present, as shown in diagrams c) and d), in which the two clock signals CLK1 and CLK2 are entirely non-overlapping, no signal is generated for CLK3.

According to the present disclosure, it may be possible to use photon counting circuitry in binned pixels (e.g., the two pixels of FIG. 3 without limiting the present disclosure in that regard). For example, if the two pixels of FIG. 3 should be binned and when they generate coincident pixel signals as described herein (i.e., the signals CLK1 and CLK2 overlap in time for a certain degree), only one count would be recorded when there is no coincidence detection. However, when the same or similar circuitry as in FIG. 3 are applied to such a binned pixel, a count number the common counter may be multiplied by two to reproduce the real event number. Thereby, more counts may be accumulated which may optimize a signal to noise ratio (which normally would correspond to the square root of the number of counts).

A further embodiment of photon counting ToF circuitry 40 including photon counting circuitry is depicted in FIGS. 5 and 6, which depict the same circuitry, but in different states of operation. FIG. 5 depicts a state in which a “coincidence counting mode” is per se deactivated and counters 41 and 42 always act together as and individual counter for SPAD 1 and counters 43 and 44 always act together as an individual counter for SPAD2. Hence, the circuitry of FIG. 5 operates as a differential mode counter.

In FIG. 6, a state is depicted in which the “coincidence counting mode” is activated, which means that it is generally possible to detect the coincidence. In this state, the counters 41 and 43 act together as a common counter for SPAD1 and SPAD2, if coincidence is determined and counters 42 and 44 are single counters, if no coincidence is present. Hence, the circuitry of FIG. 6 operates as a common mode counter.

Apart from the counters 41 to 44, photon counting circuitry 45 is depicted. As already discussed above, delay lines 46 and 47 are used for generating delayed clock signals when non-coincidence in determined. Moreover, multiplexers with control signals “ModSel” (Mode Selection) are added to switch the photon counting ToF circuitry 40 between normal mode with individual counters for each of the pixels as shown in FIG. 5 and a shared counter mode shown as in FIG. 6. This may bring in flexibility of the circuits to switch between these two modes.

When ModSel is zero (case of FIG. 5), two individual counters based on counters 41 and 42 for SPAD1 and counters 43 and 44 for SPAD2 are present. At this mode, each of the individual counters have bit length of log₂(2^{M}+2^{N}), wherein M is the bit length of counters 42 and 44 and N is the bit length of counters 41 and 43, wherein the present disclosure is not limited to any specific bit length and the bit length of counters 42 and 44 as well as 41 and 43 may differ from each other.

When ModSel is one (case of FIG. 6), coincidence counting is used. When coincidence is detected, a signal is generated by the photon counting circuitry 45 in form of a clock signal (not depicted), but similar as shown in FIG. 4a) or b).

This clock pulse is counted by a common counter formed by counters 41 and 43, as already explained above. The formed common counter has two times N bit length. When no coincidence is detected, no signal is generated by the photon counting circuitry 45 and the respective pixel signals are counted separately by the counters 42 and 44 which work as individual counters.

For example, if counter bit length N is seven and counter bit length M is five, the common counter has fourteen bits and may thus store a fourteen bit (i.e., log₂(2¹⁴+2⁵) common value and a five bit differential value, whereas in the mode in which coincidence counting is not activated at all (FIG. 5), the total bit length is twelve bit.

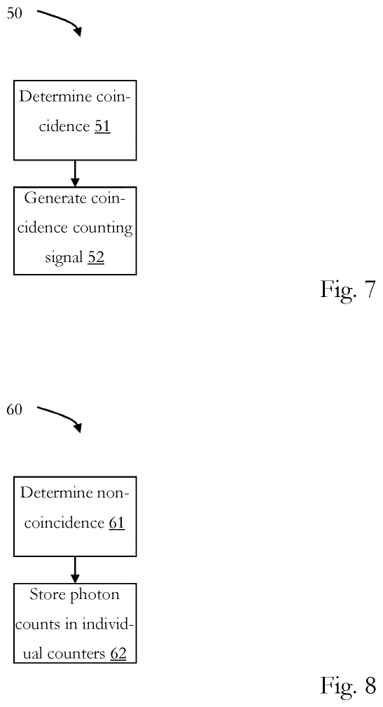

FIG. 7 depicts an embodiment of a photon counting method 50 according to the present disclosure in a block diagram.

At 51, it is determined whether coincidence is present, as discussed herein.

At 52, a coincidence counting signal is generated, if coincidence is determined, as discussed herein.

FIG. 8 depicts an embodiment of a photon counting method 60 according to the present disclosure in a block diagram.

At 61, it is determined that non-coincidence is present, as discussed herein.

At 62, photon counts are stored in individual counters, as discussed herein.

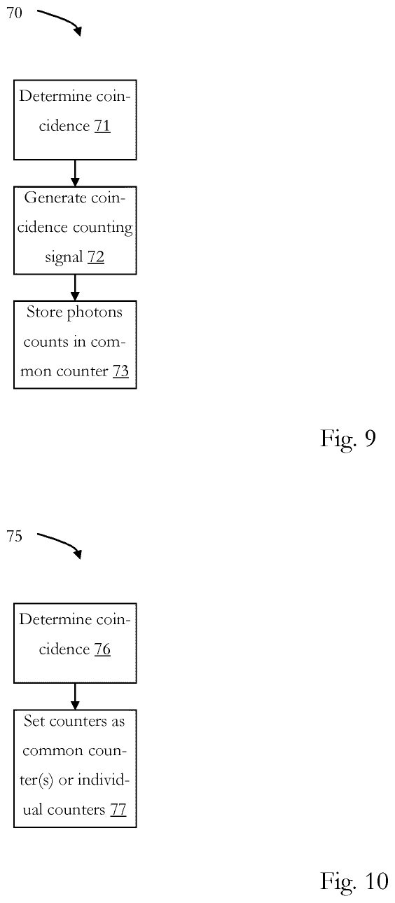

FIG. 9 depicts an embodiment of a photon counting method 70 according to the present disclosure in a block diagram.

At 71, it is determined that coincidence is present, as discussed herein.

At 72, a coincidence counting signal is generated, as discussed herein.

At 73, coincident photon counts are stored in common counters, as discussed herein.

FIG. 10 depicts an embodiment of a photon counting method 75 according to the present disclosure in a block diagram.

At 76, it is determined whether coincidence is present, as discussed herein.

At 77, respective counters are set of common counters or individual counters, depending on whether coincidence is present or not, as discussed herein.

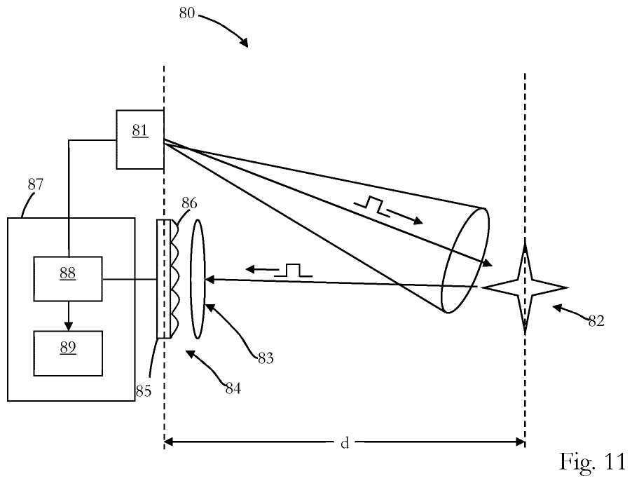

In FIG. 11, on a high level, there is illustrated an embodiment of a photon counting time-of-flight imaging system 80, which is embodied here as a photon counting ToF camera and which can be used for depth sensing or providing a distance measurement and which has photon light counting circuitry 87 which is configured to perform the methods as discussed herein and which forms a control of the photon counting ToF apparatus 80 (and it includes, not shown, corresponding processors, memory and storage (i.e., counters, as discussed herein)).

The photon counting ToF imaging system 80 has a pulsed light source 81 and it includes light emitting elements (based on laser diodes), wherein in the present embodiment, the light emitting elements are narrow band laser elements.

The light source 81 emits pulsed light to a scene 82 (region of interest or object), which reflects the light. By repeatedly emitting light to the scene 82, the scene 82 can be scanned, as it is generally known to the skilled person. The reflected light is focused by an optical stack 83 to a light detector 84.

The photon counting time-of-flight light detection circuitry 87 also forms control of the light source, such that it also includes corresponding control circuitry (not depicted).

The light detector 84 has an image sensor 85, which is implemented based on multiple SPADs (Single Photon Avalanche Diodes) formed in an array of pixels (imaging elements) and a micro lens array 86 which focuses the light reflected from the scene 82 to the image sensor 85 (to each pixel of the image sensor 85).

The light emission time information is fed from the light source 81 to the photon counting circuitry 87 including a photon counting unit 88, which also receives respective time information from the image sensor 85, when the light is detected which is reflected from the scene 82. Generally, the photon counting time-of-flight system is also capable of performing a time-of-flight measurement. On the basis of the emission time information received from the light source 81 and the time of arrival information received from the image sensor 85, the photon counting unit 88 computes a round-trip time of the light emitted from the light source 81 and reflected by the scene 82 and on the basis thereon it computes a distance d (depth information) between the image sensor 85 and the scene 82 based on a determination of light events, as discussed herein. Moreover, as discussed herein, the photon counting unit 88 has information about the time points at which common mode counting and differential mode counting was activated such that counts can be assigned respectively.

The depth information is fed from the photon counting unit 88 to a 3D image reconstruction unit 89 of the photon counting circuitry 87, which reconstructs (generates) a 3D image of the scene 82, based on the depth information received from the time-of-flight measurement unit 88.

It should be recognized that the embodiments describe methods with an exemplary ordering of method steps. The specific ordering of method steps is however given for illustrative purposes only and should not be construed as binding. Changes of the ordering of method steps may be apparent to the skilled person.

Please note that the division of the control 87 into units 88 and 89 is only made for illustration purposes and that the present disclosure is not limited to any specific division of functions in specific units. For instance, the control 87 may be implemented by a respective programmed processor, field programmable gate array (FPGA) and the like.

The methods described herein may also be implemented as a computer program causing a computer and/or a processor to perform the methods, when being carried out on the computer and/or processor. In some embodiments, also a non-transitory computer-readable recording medium is provided that stores therein a computer program product, which, when executed by a processor, such as the processor described above, causes the method described to be performed. All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Photon counting circuitry, configured to:
   determine, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
   generate a coincidence counting signal for setting the counting operation mode to the coincidence counting operation mode.
(2) The photon counting circuitry of (1), further configured to:
   determine the counting operation mode as a non-coincidence counting operation mode, if the degree of overlap in time of the at least two pixel signals is below a predetermined threshold.
(3) The photon counting circuitry of (1) or (2), further configured to:
   store, in the coincidence counting operation mode, photon counts which are indicated by the at least two pixel signals in a common counter which is common for the at least two pixels.
(4) The photon counting circuitry of (3), further configured to:
   store, in the coincidence counting operation mode, one coincident photon count of the at least two pixel signals as one count in the common counter.
(5) The photon counting circuitry of anyone of (1) to (4), further configured to:
   store, in the non-coincidence counting operation mode, photon counts which are indicated by the at least two pixel signals in individual counters for each of the at least two pixel signals.
(6) The photon counting circuitry of anyone of (1) to (5), wherein the coincidence counting signal is a clock signal.
(7) The photon counting circuitry of (6), wherein the coincidence counting signal corresponds to that pixel signal of the at least two pixel signals which is later in time.
(8) The photon counting circuitry of anyone of (1) to (7), further comprising at least three counters including at least one common counter for the coincidence counting operation mode, and at least two individual counters for the non-coincidence counting operation mode.
(9) The photon counting circuitry of anyone of (1) to (8), further comprising four counters including a first to fourth counter, the circuitry being further configured to:
   set, based on the coincidence counting signal, the first and the second counter as a common counter for the coincidence counting operation mode.
(10) The photon counting circuitry of (9), further configured to:
   set, based on an absence of the coincidence counting signal, the first and the third counter as a first individual counter and the second and the fourth counter as a second individual counter.
(11) A photon counting method, comprising:
   determining, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
   generating a coincidence counting signal for setting the counting operation mode to the coincidence counting operation mode.
(12) The photon counting method of (11), further comprising:
   determining the counting operation mode as a non-coincidence counting operation mode, if the degree of overlap in time of the at least two pixel signals is below a predetermined threshold.
(13) The photon counting method of (11) or (12), further comprising:
   storing, in the coincidence counting operation mode, photon counts which are indicated by the at least two pixel signals in a common counter which is common for the at least two pixels.
(14) The photon counting method of (13), further comprising:
   storing, in the coincidence counting operation mode, one coincident photon count of the at least two pixel signals as one count in the common counter.
(15) The photon counting method of anyone of (11) to (14), further comprising:
   storing, in the non-coincidence counting operation mode, photon counts which are indicated by the at least two pixel signals in individual counters for each of the at least two pixel signals.
(16) The photon counting method of anyone of (11) to (15), wherein the coincidence counting signal is a clock signal.
(17) The photon counting method of (16), wherein the coincidence counting signal corresponds to that pixel signal of the at least two pixel signals which is later in time.
(18) The photon counting method of anyone of (11) to (17) being applied with at least three counters including at least one common counter for the coincidence counting operation mode, and at least two individual counters for the non-coincidence counting operation mode.
(19) The photon counting method of anyone of (11) to (18) being applied with four counters including a first to fourth counter, the method further comprising:
   setting, based on the coincidence counting signal, the first and the second counter as a common counter for the coincidence counting operation mode.
(20) The photon counting method of (19), further comprising:
   setting, based on an absence of the coincidence counting signal, the first and the third counter as a first individual counter and the second and the fourth counter as a second individual counter.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. Photon counting circuitry, configured to:
determine, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
generate a coincidence counting signal for setting the counting operation mode to the coincidence counting operation mode.

2. The photon counting circuitry of claim 1, further configured to:
determine the counting operation mode as a non-coincidence counting operation mode, if the degree of overlap in time of the at least two pixel signals is below a predetermined threshold.

3. The photon counting circuitry of claim 1, further configured to:
store, in the coincidence counting operation mode, photon counts which are indicated by the at least two pixel signals in a common counter which is common for the at least two pixels.

4. The photon counting circuitry of claim 3, further configured to:
store, in the coincidence counting operation mode, one coincident photon count of the at least two pixel signals as one count in the common counter.

5. The photon circuitry of claim 1, further configured to:
store, in the non-coincidence counting operation mode, photon counts which are indicated by the at least two pixel signals in individual counters for each of the at least two pixel signals.

6. The photon counting circuitry of claim 1, wherein the coincidence counting signal is a clock signal.

7. The photon counting circuitry of claim 6, wherein the coincidence counting signal corresponds to that pixel signal of the at least two pixel signals which is later in time.

8. The photon counting circuitry of claim 1, further comprising at least three counters including at least one common counter for the coincidence counting operation mode, and at least two individual counters for the non-coincidence counting operation mode.

9. The photon counting circuitry of claim 1, further comprising four counters including a first to fourth counter, the circuitry being further configured to:
set, based on the coincidence counting signal, the first and the second counter as a common counter for the coincidence counting operation mode.

10. The photon counting circuitry of claim 9, further configured to:
set, based on an absence of the coincidence counting signal, the first and the third counter as a first individual counter and the second and the fourth counter as a second individual counter.

11. A photon counting method, comprising:
determining, based on a degree of overlap in time of at least two pixel signals of at least two pixels of a photon counting time-of-flight sensor, whether a signal coincidence of the at least two pixel signals is present, for setting a counting operation mode to a coincidence counting operation mode, if the signal coincidence is present, wherein counts of the at least two pixel signals are counted together in the coincidence counting operation mode; and
generating a coincidence counting signal for setting the counting operation mode to the coincidence counting operation mode.

12. The photon counting method of claim 11, further comprising:
determining the counting operation mode as a non-coincidence counting operation mode, if the degree of overlap in time of the at least two pixel signals is below a predetermined threshold.

13. The photon counting method of claim 11, further comprising:
storing, in the coincidence counting operation mode, photon counts which are indicated by the at least two pixel signals in a common counter which is common for the at least two pixels.

14. The photon counting method of claim 13, further comprising:
storing, in the coincidence counting operation mode, one coincident photon count of the at least two pixel signals as one count in the common counter.

15. The photon counting method of claim 11, further comprising:
storing, in the non-coincidence counting operation mode, photon counts which are indicated by the at least two pixel signals in individual counters for each of the at least two pixel signals.

16. The photon counting method of claim 11, wherein the coincidence counting signal is a clock signal.

17. The photon counting method of claim 16, wherein the coincidence counting signal corresponds to that pixel signal of the at least two pixel signals which is later in time.

18. The photon counting method of claim 11 being applied with at least three counters including at least one common counter for the coincidence counting operation mode, and at least two individual counters for the non-coincidence counting operation mode.

19. The photon counting method of claim 11 being applied with four counters including a first to fourth counter, the method further comprising:
setting, based on the coincidence counting signal, the first and the second counter as a common counter for the coincidence counting operation mode.

20. The photon counting method of claim 19, further comprising:
setting, based on an absence of the coincidence counting signal, the first and the third counter as a first individual counter and the second and the fourth counter as a second individual counter.
